(19) United States
(12) Patent Application Publication
(10) Pub. No.: US 2007/0242238 A1
(43) Pub. Date: Oct. 18, 2007

(54) Projector using laser as light source

(76) Inventor: Jerry Liao, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/645,516

(22) Filed: Dec. 27, 2006

(30) Foreign Application Priority Data
Apr. 18, 2006 (TW) 95113863

(51) Int. Cl. G03B 21/14

(52) U.S. Cl. 353/97

(57) ABSTRACT

A projector includes a laser source, a collimate lens, a deflection reflector, and a deflection controller coupled to the deflection reflector. The laser source generates a laser beam, which transmits through and is converted by the collimate lens into a collimated laser beam, which is then directed toward the deflection reflector. The deflection reflector, under the control of the deflection controller, projects the collimated laser beam to a liquid crystal panel or a digital micro-reflector element in a scanning manner so as to induce an image, which is then projected to a projection display screen.

### FIELD OF THE INVENTION

The present invention relates to a light source of a projection device, and in particular to a projector that uses a laser as a light source.

### BACKGROUND OF THE INVENTION

Projectors have been widely used in a variety of applications, including commercial advertisements, product briefs, academic conferences, speeches, home cinema facility, and commercial/industrial conferences and other commercial/industrial applications. A conventional projector is operated with reflection of light, together with transparent sheets or slides, to project texts and images carried on the transparent sheets or the slides through an optic lens.

With the development of digital technology, digital and powerful projection devices replace the conventional optic projectors to serve as a peripheral device that facilitates a display device to project texts and images on a projection display screen. Most of the currently available use a halogen lamp or a cold light as a projection light.

FIG. 1 of the attached drawings shows an optic path diagram of a conventional projector. The conventional projector, generally designated at 100, comprises a halogen lamp 11, a lens 12, and a liquid crystal panel 13. In the operation of the projector 100, the halogen lamp 11 generates a diffusible light beam L1, which transmits through the lens 12 and projects to the liquid crystal panel 13. Thus, the projector 100 generates a specific image and projects the image onto a projection display screen 14 to be observed by an observer.

It is noted that all the projection devices are operated with a projection light to perform normal projection function and conventionally, the projection light is provided by a halogen lamp or a cold light source. A halogen lamp features high lighting efficiency and low costs as compared to other projection light sources of similar power. However, the halogen lamp generates a great amount of heat, which may cause overheating of the projection device, and even causes fires on inflammable objects that are located nearby. Thus, some of the manufacturers are devoted to cooling solutions of the halogen lamp based projectors in order to overcome the overheating problem. The cooling solution, however, adds new problems of increasing requirement of space for installation.

Further, in a projection device that uses a halogen lamp as light source, the light projected by the projection device is diffused in a circular form so that when an operator adjusts the size of a projection zone, additional facility, including image conversion means and/or light shielding means, must be used to do the adjustment. This causes certain inconvenience of operating the projector.

In addition, compared to other projection lights, the halogen lamp also suffers large power consumption and high risk of malfunctioning and failure. Apparently, the service life of the projector is substantially reduced and economic operation is negatively affected.

### SUMMARY OF THE INVENTION

Thus, an objective of the present invention is to provide a projector that uses a laser source as a light source, wherein laser light is employed to serve as a projection light of the projector and a deflection reflector deflects a laser beam from the laser source to a liquid crystal panel to induce an image that is then projected to a screen.

Another objective of the present invention is to provide a projector that employs a laser source, wherein a laser beam is used as a projection light and the characteristics of laser beam related to conversion/diffusion is used to efficient and effective adjust the size of a projection zone of the projector.

To achieve the above-mentioned objectives, in accordance with the present invention, a projector comprises a laser source, a collimate lens, a deflection reflector, a deflection controller coupled to the deflection reflector, and a liquid display panel. When the projector is put into operation, the laser source generates a laser beam that is projected to the collimate lens. The collimate lens converts the laser beam from the laser source into a collimated laser beam.

The collimated laser beam from the collimate lens is projected onto the deflection reflector, which, under the control of the deflection controller, is rotatable within a predetermined deflection angle range with a reference axis as a rotation center to deflect the collimated laser beam to the liquid crystal panel in a scanning manner. The collimated laser beam, after passing through a filter of the liquid crystal panel, induces a specific image on the liquid crystal panel, which is then projected to a projection display screen to allow an observer to see the image by means of visual persistence.

In an embodiment of the present invention, a plurality of laser sources is employed to generate a plurality of laser beams, which are respectively projected toward a plurality of collimate lenses to convert the laser beams from the laser sources into collimated laser beams. The collimated laser beams are then processed by reflectors to eventually form a combined laser beam, which is deflected by the deflection reflector to project toward the liquid crystal panel.

In an embodiment of the present invention, the laser beam that is deflected by the deflection reflector is guided toward a digital micro-reflector element to generate a specific image that is projected onto the projection display screen.

Apparently, as compared to the conventional devices, the present invention uses a laser source as a projection light of the projector. This effectively overcomes the drawbacks of high temperature, high risk of malfunction, and reduced service life of the conventional projectors that use a halogen lamp as light source and also features the projector with high brightness, directivity, and monochromaticity. Also, the present invention allows for efficient and effective adjustment of size of projection zone.

### BRIEF DESCRIPTION OF THE DRAWINGS

The present invention will be apparent to those skilled in the art by reading the following description of preferred embodiments thereof, with reference to the attached drawings, in which:

FIG. 1 schematically shows optic path of diffusion light beam generated by a projection light source of a conventional projector;

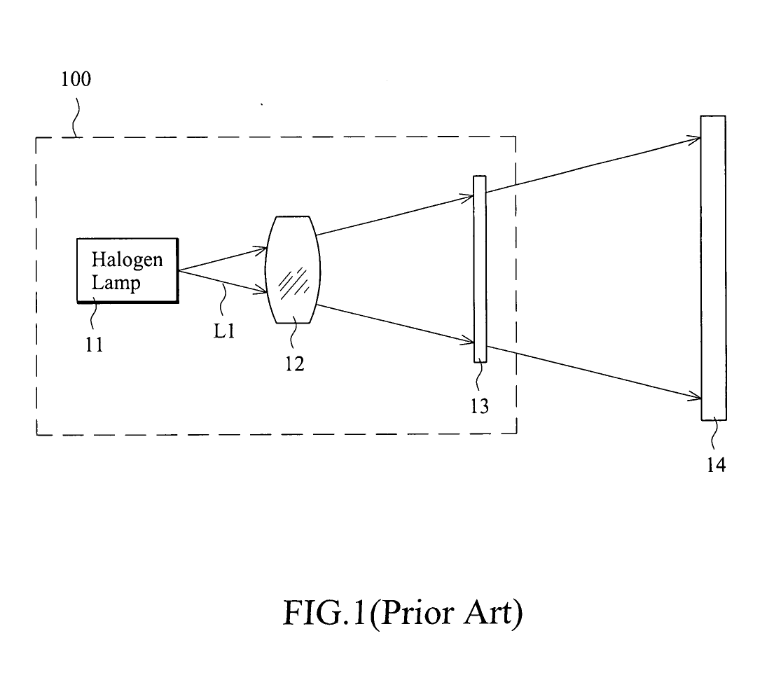

FIG. 2 schematically shows, in a side elevational view, optic path of a laser beam generated by a laser source of a projector in accordance with a first embodiment of the present invention;

FIG. 3 schematically shows, in a top view, the optic path of the laser beam generated by the laser source of the projector in accordance with the first embodiment of the present invention;

FIG. 4 schematically shows collimated-beam projection range and diffused-beam projection range of the laser beam generated by the laser source of the first embodiment of the present invention;

FIG. 5 schematically shows deflection angle range provided by a deflection reflector of the projector of the first embodiment of the present invention;

FIG. 6 schematically shows optic path of laser beams generated by laser sources of a projector in accordance with a second embodiment of the present invention; and

FIG. 7 schematically shows optic path of a laser beam generated by a laser source of a projector in accordance with a third embodiment of the present invention.

### DETAILED DESCRIPTION OF THE PREFERRED EMBODIMENTS

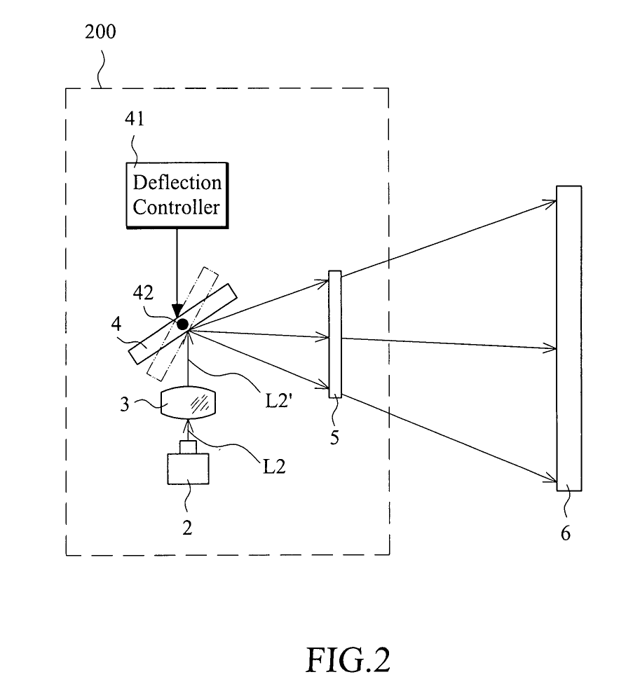

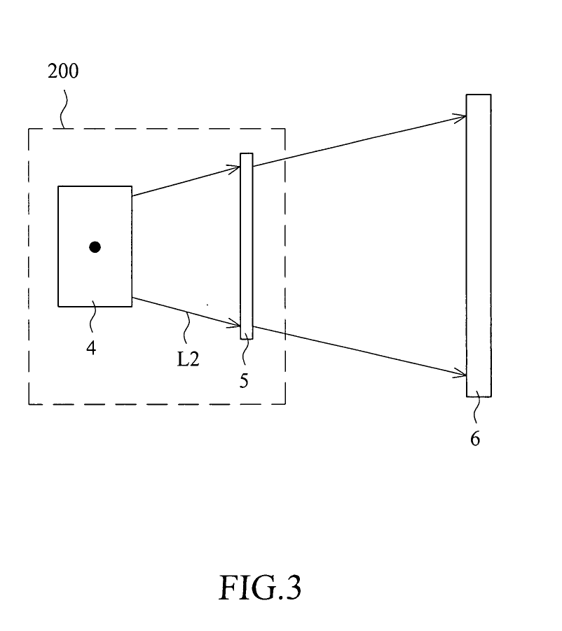

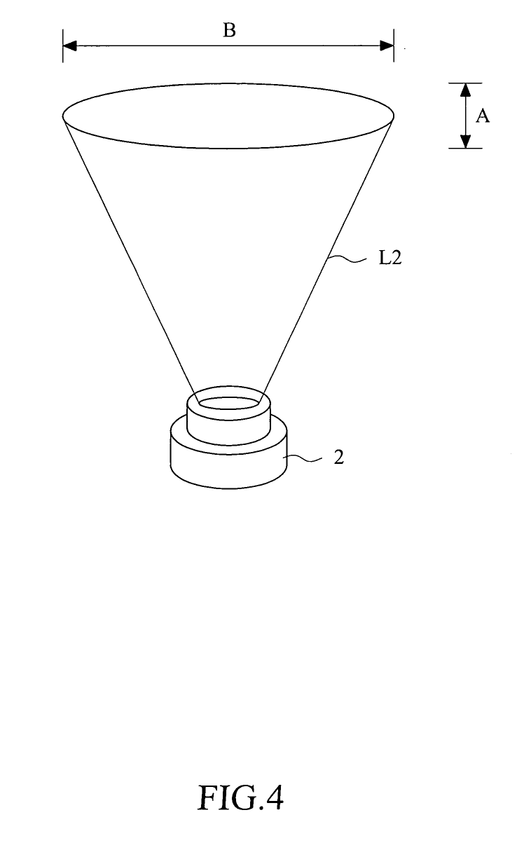

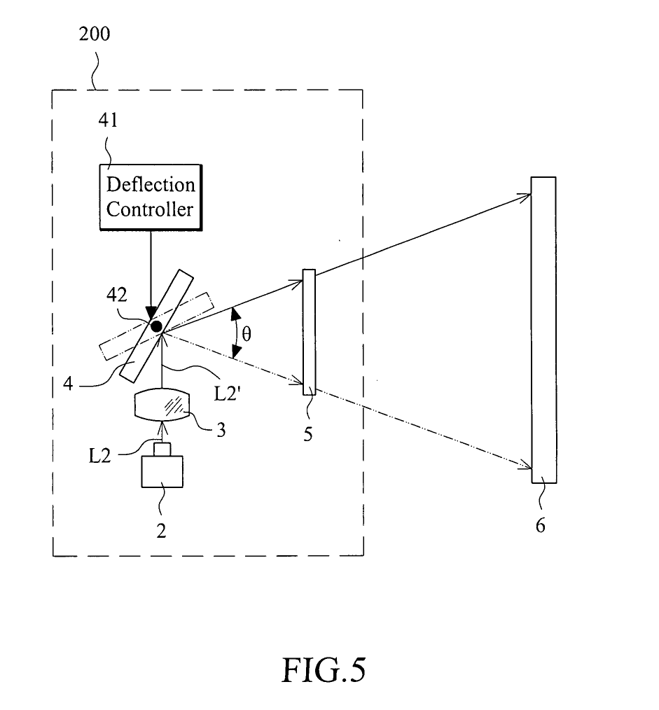

With reference to the drawings and in particular to FIGS. 2-5, a projector constructed in accordance with the present invention, generally designated with reference numeral 200, comprises a laser source 2, a collimate lens 3, a deflection reflector 4, a deflection controller 41 coupled to the deflection reflector 4, and a liquid crystal panel 5. When the projector 200 is actuated, the laser source 2 emits a laser beam L2, which is projected in a predetermined projection direction. The laser beam L2 has a longitudinal collimated-beam projection range A and a lateral diffused-beam projection range B. In the embodiment illustrated, the longitudinal collimated-beam projection range A of the laser beam L2 is around 7 to 8 degrees, while the lateral diffused-beam projection range B is around 36 degrees for the laser beam L2.

The longitudinal collimated-beam projection range A and the lateral diffused-beam projection range B of the laser beam L2 can be varied in accordance with the requirements of the projector 200. The laser source 2 is a white laser source in the embodiment illustrated, but can be of other colors in accordance with the applications of the projector 200.

The collimate lens 3 is arranged in the predetermined projection direction where the laser beam L2 travels from the laser source 2 to convert the laser beam L2 into a collimated laser beam L2′, which is projected toward the deflection reflector 4.

The deflection reflector 4 is controlled by the deflection controller 41 and is rotatable, with a reference axis 42 as a rotation center, within a predetermined deflection angle range θ. The liquid display panel 5 is arranged adjacent to the deflection reflector 4 and is located in the predetermined deflection angle range θ of the collimated laser beam L2′ projected from the deflection reflector 4. The liquid display panel 5 has longitudinal and lateral dimensions that are covered by the longitudinal collimated-beam projection range A and the lateral diffused-beam projection range B of the laser beam L2 emitted from the laser source 2.

When the collimated laser beam L2′ is projected from the collimate lens 3 to the deflection reflector 4, the collimated laser beam L2′ is deflected by the deflection reflector 4, within the predetermined deflection angle range θ, in a repeated scanning manner, to the liquid crystal panel 5, and is filtered by a filter of the liquid crystal panel 5 to produce a specific image on the liquid crystal panel 5, which image is thus projected to a display screen 6, so that an observer can see the image projected from the projector 200 by means of visual persistence.

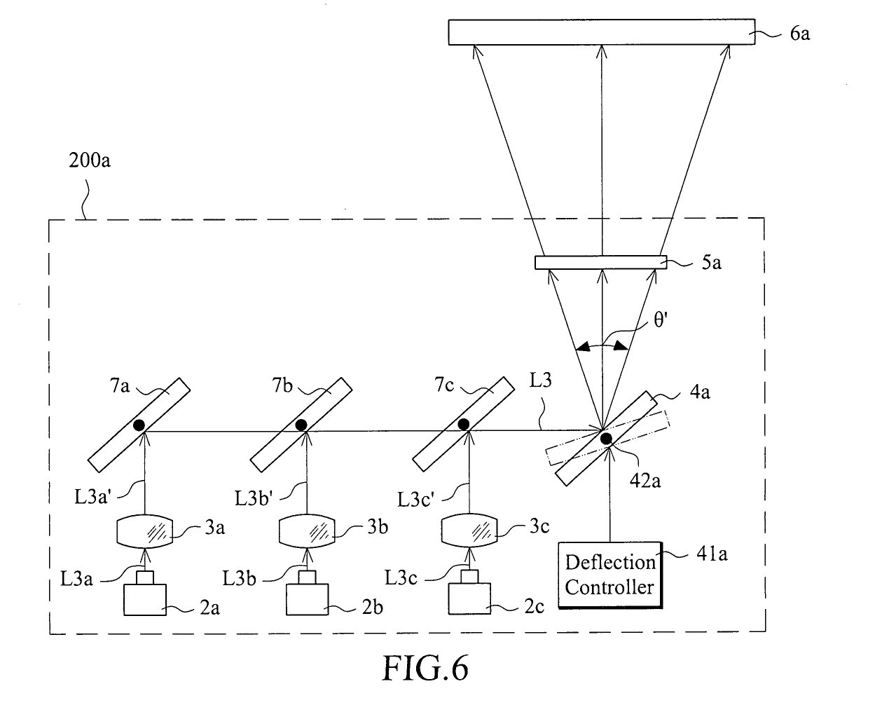

As shown in FIG. 6, which shows a schematic view of optic path of a laser beam generated by laser sources in accordance with a second embodiment of the present invention, a projector in accordance with the present invention, designated with reference numeral 200a, comprises three laser sources 2a, 2b, 2c, three collimate lenses 3a, 3b, 3c, three reflectors 7a, 7b, 7c, a deflection reflector 4a, a deflection controller 41a coupled between the deflection reflector 4a and a liquid crystal panel 5a.

The laser sources 2a, 2b, 2c generate laser beams L3a, L3b, L3c, respectively, which are projected in predetermined projection directions. The laser beams L3a, L3b, L3c are of the same longitudinal collimated-beam projection range A and lateral diffused-beam projection range B as the laser beam L2 generated from the laser source 2. Thus, the laser beams L3a, L3b, L3c have a longitudinal collimated-beam projection range A of around 7-8 degrees and a lateral diffused-beam projection range B of around 36 degrees.

The longitudinal collimated-beam projection range A and the lateral diffused-beam projection beam B of the laser beams L3a, L3b, L3c can be adjusted in accordance with requirements set for the projector 200a. The laser source 2a can be a red laser source, the laser source 2b a green laser source, laser source 2c a blue laser source. The laser beams L3a, L3b, L3c generated from the laser sources 2a, 2b, 2c can also be changed to other colors in accordance with different applications of the projector 200a.

The collimate lenses 3a, 3b, 3c are arranged in the predetermined projection directions of the laser beams L3a, L3b, L3c from the laser sources 2a, 2b, 2c to respectively convert the laser beams L3a, L3b, L3c into collimated laser beams L3a′, L3b′, L3c′, which are then projected toward the reflectors 7a, 7b, 7c, respectively.

The reflector 7a is a total reflection reflector, which reflects the collimated red laser beam L3a′ from the collimate lens 3a in a total reflection manner. The reflector 7b is a semi-reflection reflector, which reflects the collimated green laser beam L3b′ from the collimate lens 3b in a semi-reflection manner and allows the collimated red laser beam L3a′ that is previously subject to total reflection by the reflector 7a to transmit therethrough to travel along with the collimated green laser beam 73b′ that is subject to semi-reflection by the reflector 7b.

The reflector 7c is a semi-reflection reflector, which reflects the collimated blue laser beam L3c′ from the collimate lens 3c in a semi-reflection manner and allows the collimated red laser beam L3a′ that is previously subject to total reflection by the reflector 7a and the collimated green laser beam L3b′ that is previously subject to total reflection by the reflector 7b to transmit therethrough to combine with the collimated blue laser beam 73c′ that is subject to semi-reflection by the reflector 7c, thereby forming a combined white laser beam L3, which is projected toward the deflection reflector 4a.

The deflection reflector 4a is controlled by the deflection controller 41a and is rotatable, with a reference axis 42a as a rotation center, within a predetermined deflection angle range θ′. The liquid display panel 5a is arranged adjacent to the deflection reflector 4a and is located in the predetermined deflection angle range θ′ of the collimated laser beam L3 projected from the deflection reflector 4a. The liquid display panel 5a has longitudinal and lateral dimensions that are covered by the longitudinal collimated-beam projection range A and the lateral diffused-beam projection range B of the laser beams L3a, L3b, L3c emitted from the laser sources 2a, 2b, 2c.

When the combined white laser beam L3 that is formed by the light components from the reflectors 7a, 7b, 7c is projected toward the deflection reflector 4a, the combined laser beam L3 is deflected by the deflection reflector 4a, within the predetermined deflection angle range θ′, in a repeated scanning manner, to the liquid crystal panel 5a, and is filtered by a filter of the liquid crystal panel 5a to produce a specific image on the liquid crystal panel 5a, which image is thus projected to a display screen 6a, so that an observer can see the image projected from the projector 200a by means of visual persistence.

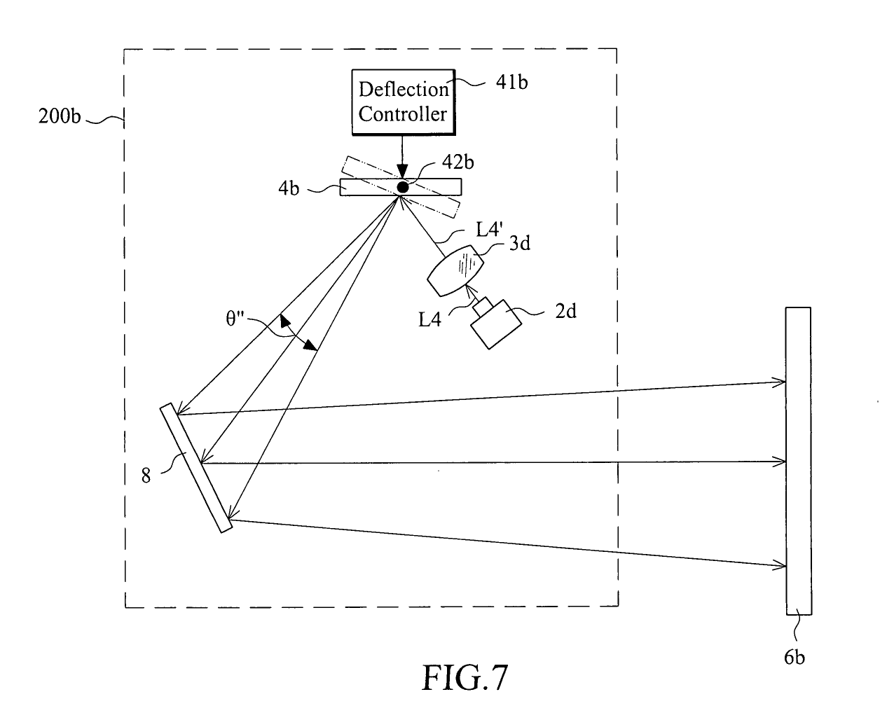

As shown in FIG. 7, which shows a schematic view of optic path of a laser beam generated by a laser source in accordance with a third embodiment of the present invention, a projector in accordance with the present invention, generally designated with reference numeral 200b, comprises a laser source 2d, a collimate lens 3d, a deflection reflector 4b, a deflection controller 41b coupled to the deflection reflector 4b, and a digital micro-reflector element 8.

When the projector 200b is actuated, the laser source 2d emits a laser beam L4, which is projected in a predetermined projection direction. The laser beam L4 has the same longitudinal collimated-beam projection range A and lateral diffused-beam projection range B as the laser beam L2 generated from the laser source 2. Thus, the longitudinal collimated-beam projection range A of the laser beam L4 is around 7 to 8 degrees, while the lateral diffused-beam projection range B of the laser beam L4 is around 36 degrees.

The longitudinal collimated-beam projection range A and the lateral diffused-beam projection range B of the laser beam L4 can be adjusted in accordance with the requirements set for the projector 200b. The laser source 2d is a white laser source in the embodiment illustrated, but can be of other colors in accordance with the applications of the projector 200b.

The collimate lens 3d is arranged in the predetermined projection direction where the laser beam L4 travels from the laser source 2 to convert the laser beam L4 into a collimated laser beam L4′, which is projected toward the deflection reflector 4b.

The deflection reflector 4b is controlled by the deflection controller 41b and is rotatable, with a reference axis 42b as a rotation center, within a predetermined deflection angle range θ″. The digital micro-reflector element 8 is arranged adjacent to the deflection reflector 4b and is located in the predetermined deflection angle range θ″ of the collimated laser beam L4′ projected from the deflection reflector 4b. The digital micro-reflector element 8 has longitudinal and lateral dimensions that are covered by the collimated-beam projection range A and the diffused-beam projection range B of the laser beam L4 emitted from the laser source 2d.

When the collimated laser beam L4′ is projected from the collimate lens 3d to the deflection reflector 4b, the collimated laser beam L4′ is deflected by the deflection reflector 4b, within the predetermined deflection angle range θ″, in a repeated scanning manner, to the digital micro-reflector element 8 so as to produce a specific image by means of the digital micro-reflector element 8, which image is projected onto a display screen 6b, whereby an observer can see the image projected from the projector 200b by means of visual persistence.

In the practical applications of the projectors 200, 200a, 200b, the laser sources 2, 2a, 2b, 2c, 2d can be ordinary semiconductor laser or carbon dioxide laser.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A projector comprising:
a laser source, which generates a laser beam projected in a predetermined projection direction, the laser beam having a longitudinal collimated-beam projection range and a lateral diffused-beam projection beam;
a collimate lens, which is arranged in the predetermined projection direction of the laser beam from the laser source to convert the laser beam from the laser source into a collimated laser beam that is projected in a predetermined projection direction;
a deflection reflector, which is arranged in the predetermined projection direction of the collimated laser beam from the collimate lens to deflect the collimated laser beam;
a deflection controller, which is coupled to the deflection reflector to control rotation of the deflector reflector so that the deflection reflector is rotatable about a reference axis within a predetermined deflection angle range; and
a liquid crystal panel, which is arranged adjacent to the deflection reflector and is located within the predetermined deflection angle range of the collimated laser beam deflected by the deflection reflector.

2. The projector as claimed in claim 1, wherein the diffused-beam projection range of the laser beam from the laser source covers a lateral dimension of the liquid crystal panel and the collimated-beam projection range covers a longitudinal dimension of the liquid crystal panel.

3. The projector as claimed in claim 1, wherein the collimated laser beam formed by the collimate lens is reflected by the deflection reflector, within the predetermined deflection angle range, to project to the liquid crystal panel in a scanning manner so as to induce an image in the liquid crystal panel that is projected to a projection display screen.

4. The projector as claimed in claim 1, wherein the laser source comprises a white laser source.

5. A projector comprising:
a plurality of laser sources, each of which generates a laser beam projected in a predetermined projection direction, the laser beam having a longitudinal collimated-beam projection range and a lateral diffused-beam projection beam;
a plurality of collimate lenses, which are arranged in the predetermined projection directions of the laser beams from the laser sources to convert the laser beams from the laser sources into collimated laser beams that are projected in predetermined projection directions;
a plurality of reflectors, which are arranged in the predetermined projection directions of the collimated laser beam from the collimate lens to deflect the collimated laser beams to form a combined laser beam that is projected in a predetermined projection direction;
a deflection reflector, which is arranged in the predetermined projection direction of the combined laser beam to deflect the combined laser beam;
a deflection controller, which is coupled to the deflection reflector to control rotation of the deflector reflector so that the deflection reflector is rotatable about a reference axis within a predetermined deflection angle range; and
a liquid crystal panel, which is arranged adjacent to the deflection reflector and is located within the predetermined deflection angle range of the combined laser beam deflected by the deflection reflector.

6. The projector as claimed in claim 5, wherein the diffused-beam projection range of the laser beam from the laser source covers a lateral dimension of the liquid crystal panel and the collimated-beam projection range covers a longitudinal dimension of the liquid crystal panel.

7. The projector as claimed in claim 5, wherein the laser sources comprise red, green, and blue laser sources, the laser beams from the laser sources being respectively collimated by the collimate lens to form the collimated laser beams, which are reflected by the respective reflectors to form a combined white laser beam.

8. The projector as claimed in claim 5, wherein the combined laser beam is reflected by the deflection reflector, within the predetermined deflection angle range, to project to the liquid crystal panel in a scanning manner so as to induce an image in the liquid crystal panel that is projected to a projection display screen.

9. A projector comprising:
a laser source, which generates a laser beam projected in a predetermined projection direction, the laser beam having a longitudinal collimated-beam projection range and a lateral diffused-beam projection beam;
a collimate lens, which is arranged in the predetermined projection direction of the laser beam from the laser source to convert the laser beam from the laser source into a collimated laser beam that is projected in a predetermined projection direction;
a deflection reflector, which is arranged in the predetermined projection direction of the collimated laser beam from the collimate lens to deflect the collimated laser beam;
a deflection controller, which is coupled to the deflection reflector to control rotation of the deflector reflector so that the deflection reflector is rotatable about a reference axis within a predetermined deflection angle range; and
a digital micro-reflector element, which is arranged adjacent to the deflection reflector and is located within the predetermined deflection angle range of the collimated laser beam deflected by the deflection reflector.

10. The projector as claimed in claim 9, wherein the diffused-beam projection range of the laser beam from the laser source covers a lateral dimension of the digital micro-reflector element and the collimated-beam projection range covers a longitudinal dimension of the digital micro-reflector element.

11. The projector as claimed in claim 9, wherein the collimated laser beam formed by the collimate lens is reflected by the deflection reflector, within the predetermined deflection angle range, to project to the digital micro-reflector element in a scanning manner so as to induce an image in the digital micro-reflector element that is reflected to a projection display screen.

12. The projector as claimed in claim 9, wherein the laser source comprises a white laser source.
